(19) United States
(12) Patent Application Publication
(10) Pub. No.: US 2018/0202800 A1
(43) Pub. Date: Jul. 19, 2018

(54) LINEAR LIGHT IRRADIATION DEVICE

(71) Applicant: CCS Inc., Kyoto-shi, Kyoto (JP)

(72) Inventor: Kenji Sakurai, Kyoto-shi (JP)

(21) Appl. No.: 15/744,036

(22) PCT Filed: Jun. 22, 2016
(86) PCT No.: PCT/JP2016/068466

§ 371 Date: Jan. 11, 2018

(30) Foreign Application Priority Data
Jul. 29, 2015 (JP) 2015-149205

(51) Int. Cl. G01B 11/24; G01N 21/84; F21V 29/76; G01B 11/02

(52) U.S. Cl. CPC G01B 11/24; G01B 11/02; F21V 29/76; G01N 21/84

(57) ABSTRACT

In order to provide a linear light irradiation device that prevents the widening of the line width of linear light and improves measurement accuracy, the linear light irradiation device includes: a plurality of LEDs that are linearly arrayed; a light condensing member that condenses light emitted from each of the LEDs; and a first slit member formed with a first slit that extends along an array direction in which the plurality of LEDs are arrayed and allows a portion of light emitted from each of the LEDs to pass, and the first slit member is integrally provided with a plurality of light blocking members that are arranged at intervals in the array direction.

### TECHNICAL FIELD

The present invention relates to a linear light irradiation device used, for example, when inspecting the surface profile of an inspection object.

### BACKGROUND ART

Methods for inspecting the surface profile of an inspection object include a light section method of inspecting a surface profile from the result of irradiating an inspection object with linear light having a very narrow line width and imaging light reflected from the inspection object by an area sensor or the like, and as a linear light irradiation device used for the light section method, there is a device described in, for example, Patent Literature 1.

The device in Patent Literature 1 includes: a plurality of LEDs that are linearly arrayed; a slit plate having a slit-shaped light emitting window (hereinafter also referred to as a slit) that is arranged on the light emitting side of the plurality of LEDs and extends in an array direction of the LEDs; and a cylindrical lens that condenses light having passed through the slit. In addition, the device is adapted to convert the light emitted from the LEDs to linear light through the slit, and condense the light having passed through the slit by a condenser lens to thereby form linear light having a very narrow line width.

### CITATION LIST

### Patent Literature

Patent Literature 1

Japanese Unexamined Patent Publication JP-A 2001-215115

### SUMMARY OF INVENTION

### Technical Problem

Meanwhile, the light emitted from each of the LEDs spreads in all directions including an X direction that is the array direction of the LEDs (an extending direction of the slit), a Y direction that is a width direction of the slit, and a Z direction that is a light axis direction of the LEDs, and as illustrated in FIG. 8, a light spreading in the X direction passes through the slit and travels. In this case, the light spreading in the X direction needs a longer distance before reaching a condenser lens such as a cylindrical lens as compared with light traveling along the light axis in the Z direction. For this reason, as compared with the light traveling in the Z direction, the light spreading in the X direction and to be incident on the condenser lens spreads in the Y direction, and also as compared with the light traveling in the Z direction, the light spreading in the X direction is likely to increase the aberration of the condenser lens, so that a condensing position by the condenser lens changes to make it difficult to uniform the line width of the linear light. In addition, such a problem is noticeable particularly at both end parts of the linear light, and the line width at the both end parts is likely to become thicker as compared with the central part. As a result, it becomes difficult to accurately measure an inspection object.

Also, in recent years, it has been demanded to inspect a large-sized inspection object at once, and in order to respond to the demand, it is necessary to make the X direction length of linear light longer than the inspection object. However, when making a slit longer in the X direction, it becomes difficult to keep the width of the slit uniform, and the effect of deflection of a slit plate is also exerted. Further, in cases such as when combining multiple members to form the slit, force acting at the time of assembling or attaching them or the like may also cause nonuniformity of the width of the slit. This also causes a problem in which the line width of the linear light cannot be uniformed, and consequently measurement accuracy is reduced as described above.

The present invention is made in consideration of the above-described issues, and a main object thereof is to provide a linear light irradiation device capable of preventing the widening of the line width of linear light and uniforming the line width.

### Solution to Problem

The linear light irradiation device of the present invention is a linear light irradiation device adapted to apply linear light, and includes: a plurality of LEDs that are linearly arrayed; a light condensing member that condenses light emitted from each of the LEDs; and a first slit member formed with a first slit that extends along an array direction in which the plurality of LEDs are arrayed and allows a portion of the light emitted from each of the LEDs to pass, and the first slit member is integrally provided with a plurality of light blocking members that are arranged at intervals in the array direction.

Since the plurality of light blocking members are provided at the intervals in the array direction as described above, the light blocking members block the light spreading in the array direction at a predetermined angle or more with respect to a light axis direction of the LEDs, and allow only light within a predetermined angle range centering on light axes of the LEDs to pass toward the light condensing member side. Accordingly, the line width of the linear light can be prevented from being widened by the light spreading in the array direction of the LEDs and also spreading in the width direction of the first slit, and the line width can be uniformed. This makes it possible to, for example, increase the accuracy of measuring an inspection object.

Also, since the light blocking members and the first slit member are integrally provided to increase the rigidity of the first slit member, even when increasing the length of the first slit in the extension direction (the array direction of the LEDs), the opening width of the first slit can be prevented from being widened. This also makes it possible to prevent the accuracy of measuring an inspection object from deteriorating.

Further, since the first slit member is integrally provided with the light blocking members, as compared with the case where these are formed of different members, the number of parts can be reduced.

As one specific embodiment of the linear light irradiation device of the present invention, one in which the first slit member is formed of a flat plate-shaped member through which the first slit penetrates in a thickness direction, and each of the light blocking members is formed of a plate-shaped body that crosses the first slit and rises from a surface of the first slit member can be cited.

When light is blocked by the first slit member, the blocked light causes the first slit member to generate heat; however, the light blocking members integrally provided therewith function as heat radiation fins, and therefore the heat of the first slit member can be radiated by the light blocking members. This makes it possible to prevent thermal deformation of the first slit member, and prevent the opening width of the first slit from being made nonuniform by thermal deformation.

As another specific embodiment of the linear light irradiation device of the present invention, one in which each of the light blocking members is formed by a bending process to be in a state of crossing the first slit and rising from the surface of the first slit member can be cited.

Configuring as described above makes it possible to form the first slit member and the light blocking members integrally provided therewith by performing the bending process on, for example, one member, and therefore the linear light irradiation device can be configured at low cost.

Also, as a still another specific embodiment of the linear light irradiation device of the present invention, one in which the first slit member is formed of a flat plate-shaped member through which the first slit penetrates in a thickness direction, and the plurality of light blocking members are arranged inside the first slit so as to partition the first slit can be cited.

In such a configuration, the light blocking members are arranged inside the slit, and therefore as compared with the case where the light blocking members are provided outside the first slit member, the device can be further miniaturized.

Further, as yet another specific embodiment of the linear light irradiation device of the present invention, one in which the first slit member is arranged between the plurality of LEDs and the light condensing member, and the light blocking members are arranged on the side of the light condensing member can be cited.

In such a configuration, as compared with when the light blocking members are arranged on the LEDs side, much more light can pass through the slit, thus making it possible to improve light utilization efficiency as well as to save space.

In addition, as yet still another specific embodiment of the linear light irradiation device of the present invention, one further including a second slit member formed with a second slit that allows a portion of the light condensed by the light condensing member to pass can be cited.

By further including the second slit member as described above, the line width of the linear light can be further adjusted, and a narrower linear light making the boundary between a light irradiation part and a non-irradiation part sharp can be formed. In addition, the relationship in slit width between the second slit and the first slit is preferably such that both are the same or the first slit is narrower, and this is because unless the line width of the linear light is controlled by the first slit nearer to the light source, it cannot be controlled by the optical system (the light condensing member and the second slit) far from the light source in many cases, and a desired linear light line width cannot be obtained. Note that the present invention does not exclude the case where the second slit is wider than the first slit.

### Advantageous Effects of Invention

According to the present invention, a linear light irradiation device capable of preventing the widening of the line width of linear light and uniforming the line width can be provided.

### BRIEF DESCRIPTION OF DRAWINGS

FIG. 1 is a perspective view illustrating a linear light irradiation device including an internal structure in a first embodiment.

FIG. 2 is a schematic view illustrating the linear light irradiation device in the first embodiment.

FIG. 3 is a schematic view illustrating traces of light from the linear light irradiation device in the first embodiment.

FIG. 4 is a perspective view illustrating a first slit plate and light blocking plates in the first embodiment.

FIG. 5 is a perspective view illustrating a first slit plate and light blocking members in a second embodiment.

FIG. 6(a) is a perspective view illustrating the front surface side of a first slit plate and light blocking plates in a third embodiment.

FIG. 6(b) is a perspective view illustrating the back surface side of the first slit plate and the light blocking plates in the third embodiment.

FIG. 7 is a schematic view illustrating a manufacturing process for the first slit plate and the light blocking plates in the third embodiment.

FIG. 8 is a schematic view illustrating a conventional linear light irradiation device.

### LIST OF REFERENCE CHARACTERS

1 Linear light irradiation device
2 LED
3 Condenser lens
4 Light blocking plate
5 Second slit plate
11 Plurality of slits
12 First slit plate
13 Heat radiation fin

### DESCRIPTION OF EMBODIMENTS

Embodiments of the linear light irradiation device of the present invention will be described below with reference to the drawings. Note that the linear light irradiation device according to the present invention is not limited to inspecting an inspection object as an application, but can also be applied to curing, drying, and the like by ultraviolet light without any limitation.

### First Embodiment

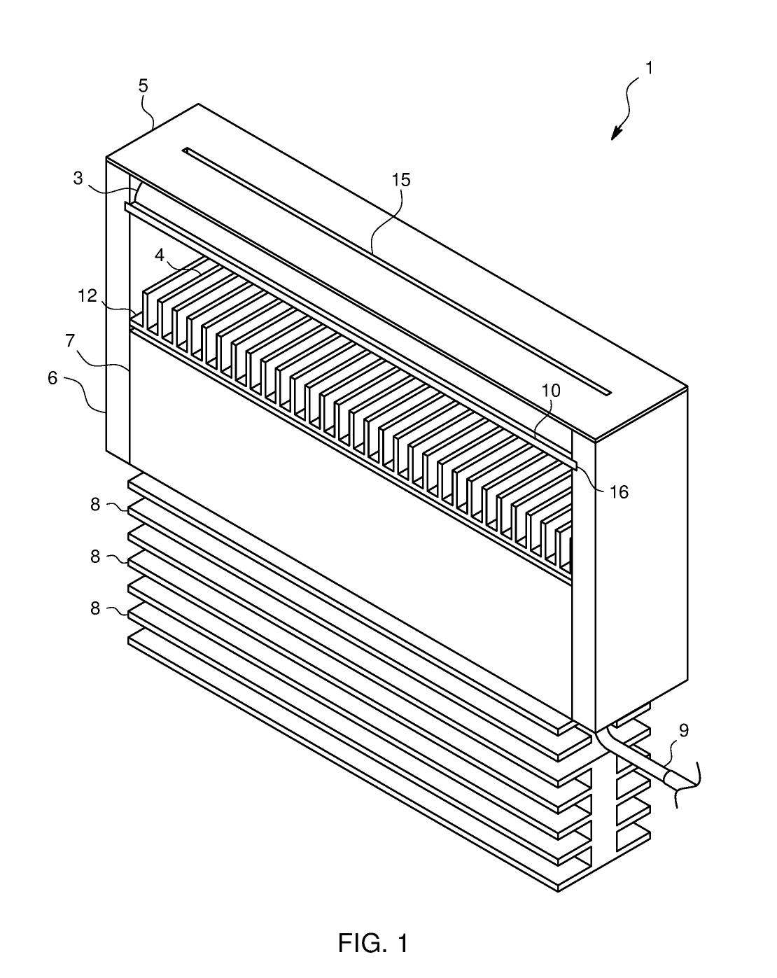

As illustrated in FIGS. 1, 2, and 3, a linear light irradiation device 1 of a first embodiment includes: a plurality of LEDs 2 that are linearly arrayed; a condenser lens 3 adapted to condense light emitted from the multiple LEDs 2; a first slit plate 12 arranged between the plurality of LEDs 2 and the condenser lens 3; a second slit plate 5 arranged on the light emitting side of the condenser lens 3; and a case 6 that contains the plurality of LEDs 2, condenser lens 3, first slit plate 12, and second slit plate 5.

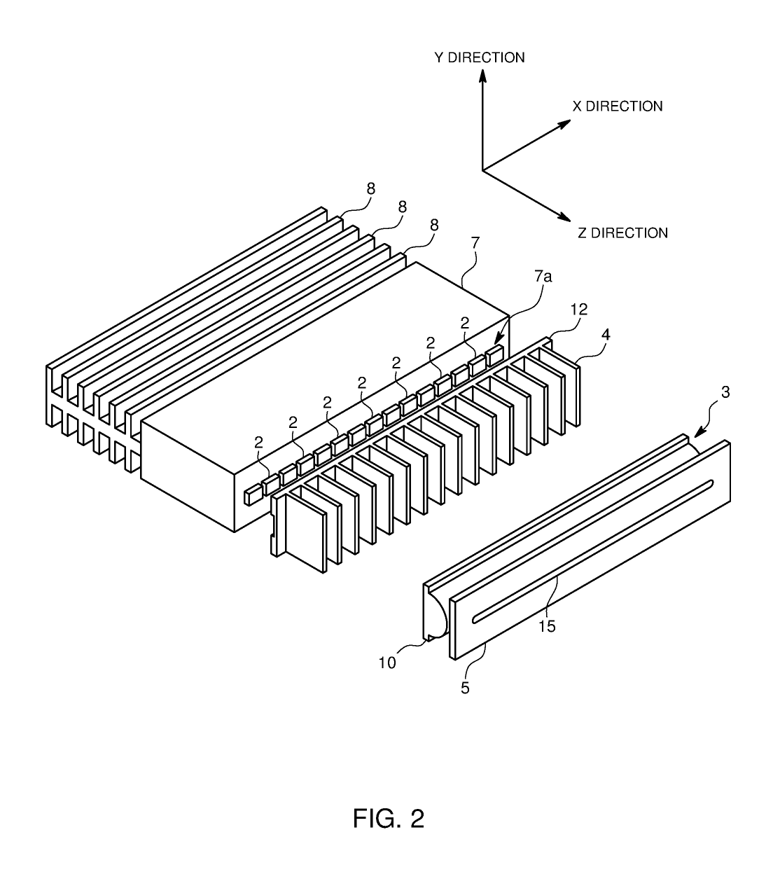

Note that in the following description, as illustrated in FIG. 2, the array direction of the LEDs 2 is defined as an X direction, the light axis direction of the LEDs 2 as a Z direction, and the direction orthogonal to the XZ plane (a slit width direction) as a Y direction.

The plurality of LEDs 2 are provided on an upper surface of a heat sink 7, and the mounting surface of the LEDs 2 is a light emitting surface 7a. The surface opposite to the light emitting surface 7a is connected with a plurality of fins 8 for radiating heat generated from the plurality of LEDs 2. Also, one lateral surface of the heat sink 7 is connected with wiring 9 for supplying electric power to the multiple LEDs 2. Note that in the present embodiment, as the LEDs 2, chip-type ones are used, but shell-type ones may be used. Also, the light emitted from the LEDs 2 is not only visible light (e.g., white) but may be ultraviolet light or infrared light.

As illustrated in FIG. 2, the condenser lens 3 is adapted to condense the light emitted from the plurality of LEDs 2 to a predetermined position, and formed of a cylindrical lens or the like. In the present invention, it is a long semicylindrical lens having a cross-sectionally semicircular shape, and the bottom surface thereof is provided with a flat plate-shaped edge part 10. In addition, as the condenser lens 3, not the semicylindrical one but a cylindrical one may be used. The condenser lens 3 corresponds to a light condensing member in the claims.

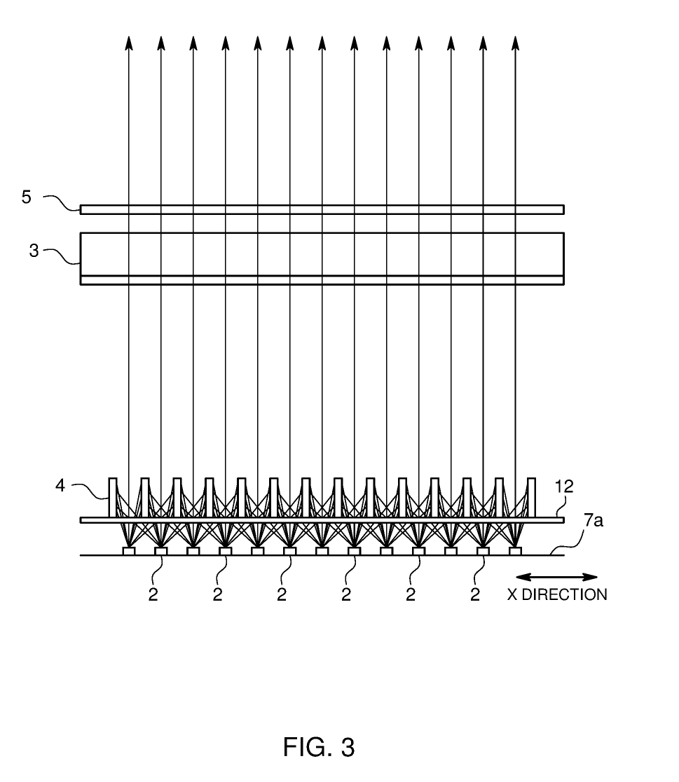

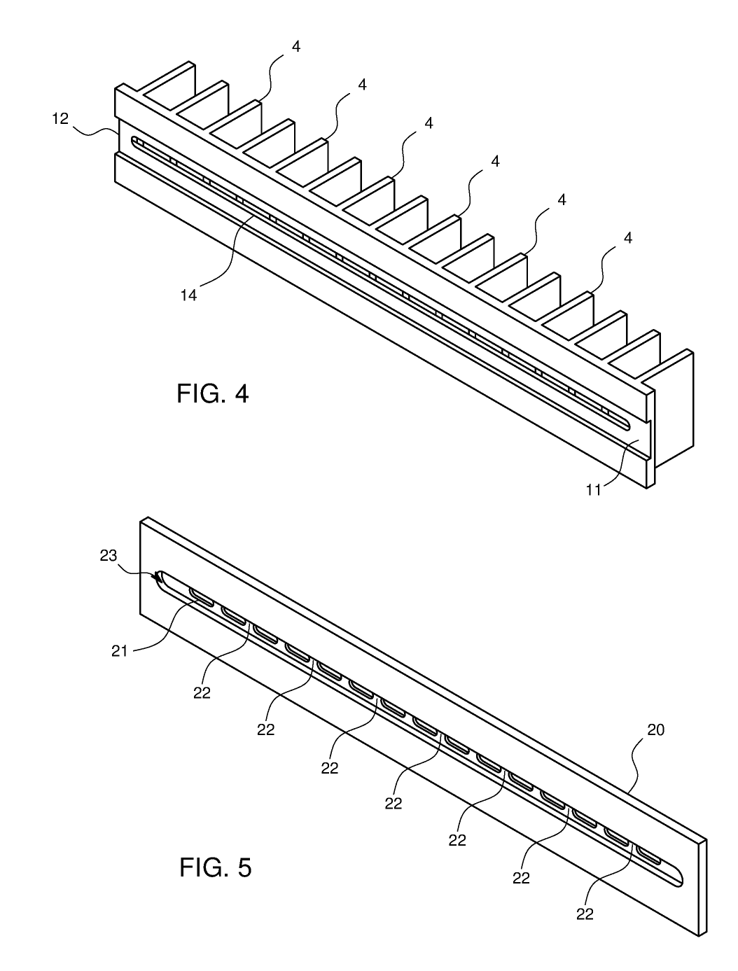

Further, as illustrated in FIGS. 3 and 4, the first slit plate 12 is such that a long first slit 14 extending in the X direction is provided penetrating in the thickness direction thereof (Z direction). In the present embodiment, substantially the central part of the first slit plate 12 in the Y direction is formed with a concave-shaped groove 11 extending in the X direction, and the first slit 14 is formed in the groove 11. Forming the first slit 14 in a part corresponding to the groove 11 having thin thickness allows a distance the light passes through the first slit 14 to be shortened, and light reflected by the inner peripheral surface of the first slit 14 can be reduced. The first slit plate 12 corresponds to a first slit member in the claims.

In addition, the first slit plate 12 is integrally provided with multiple light blocking plates 4 arranged along the Y direction and at intervals in the X direction. The light blocking plates 4 are arranged so as to cross the first slit 14 in the Y direction and to rise from the surface of the first slit plate 12. By arranging the light blocking plates 4 as described above, light spreading in the X direction at a predetermined angle or more with respect to the Z direction is blocked by the lateral surfaces of the light blocking plates 4, and also the light blocking plates 4 can be functioned as heat radiation fins.

The second slit plate 5 is, for example, one formed with a second slit 15 adapted to determine the line width of linear light that is to irradiate an inspection object, and specifically one such that a long second slit 15 extending in the X direction is provided penetrating in the thickness direction thereof (Z direction). Note that the width of the second slit 15 in the Y direction is preferably formed to be the same as or larger than the width of the first slit 14 in the Y direction. The second slit plate 5 corresponds to a second slit member in the claims.

As illustrated in FIG. 1, the case 6 is a tubular-shaped one opened upward and downward, and the second slit plate 5 is arranged so as to close the upper opening. Note that FIG. 1 is a drawing in which a front plate is omitted in order to show an internal structure.

Also, the heat sink 7 is fitted into the lower opening of the case 6, and the plurality of fins 8 and the wiring 9 connected to the heat sink 7 protrude from the lower side of the case 6.

The edge part 10 of the condenser lens 3 is fitted into concave parts 16 provided in inner surfaces of the case 6. This configuration uniquely determines the position of the condenser lens 3, and therefore a product-dependent variation can be prevented. Also, in this state, the condenser lens 3 is arranged near the second slit member 5, and therefore the device can be miniaturized.

Between the condenser lens 3 and the light emitting surface 7a, the first slit plate 12 is arranged. In this state, the light blocking plates 4 are arranged on the condenser lens 3 side. For this reason, as compared with when the light blocking plates 4 are arranged on the LEDs 2 side, much more light can pass through the first slit 14 to improve light utilization efficiency as well as to save space.

Further, the light blocking plates 4 and the LEDs 2 have a non-overlapping positional relationship in the X direction, and the light axes of the LEDs 2 are adapted not to be blocked by the lower surfaces (surfaces on the LEDs 2 side) of the light blocking plates 4.

The operation of the linear light irradiation device 1 configured as described above will be described below.

When the light is emitted from the plurality of LEDs 2, the emitted light radially spreads, and a portion of it passes through the first slit 14 and gaps between the light blocking plates 4, and reaches the condenser lens 3. Specifically, the light spreading in the Y direction at a predetermined angle or more with respect to the Z direction is blocked by the first slit plate 12 without passing through the first slit 14; of the light having passed through the first slit 14, the light spreading in the X direction at a predetermined angle or more is blocked by the lateral surfaces of the light blocking plates 4 as illustrated in FIG. 3; and the light blocked by neither the first slit plate 12 nor the light blocking plates 4, i.e., only the light within a predetermined angle range centering on the Z direction, reaches the condenser lens 3.

The light heading toward the condenser lens 3 travels while gradually spreading in the Y direction, is incident on the condenser lens 3, and is condensed to a predetermined condensing position by the condenser lens 3 where the light is converted to linear light having a sharpened edge. Then, finally, the second slit plate 5 allows a portion of the light condensed by the condenser lens 3 to pass, and therefore the inspection object is irradiated with the linear light having a more uniform line width.

The linear light irradiation device 1 of the first embodiment configured as described above has the following remarkable effects.

That is, since the plurality of light blocking plates 4 are provided on the first slit plate 12 at the intervals in the X direction, the light blocking plates 4 block the light spreading in the X direction at the predetermined angle or more with respect to the Z direction, and allow only the light within the predetermined angle range centering on the Z direction to pass toward the condenser lens 3 side. This makes it possible to prevent light spreading in the X direction from widening the line width of linear light, and to uniform the line width. In doing so, the inspection object can be highly accurately measured.

Also, the light blocking plates 4 and the first slit plate 12 are integrally provided, and the rigidity of the first slit plate 12 is high, so that even when increasing the length of the first slit 14 in the X direction, the opening width of the first slit 14 can be prevented from widening. This also makes it possible to prevent measurement accuracy from deteriorating.

Further, since the light blocking plates 4 are formed integrally with the first slit plate 12, as compared with the case where these are formed of different members, the number of parts can be reduced.

### SECOND EMBODIMENT

A linear light irradiation device of a second embodiment is such that the configuration of a first slit plate 20 is different from that in the first embodiment. However, the other parts are the same as in the first embodiment, and therefore the same parts are denoted by the same symbols to omit description.

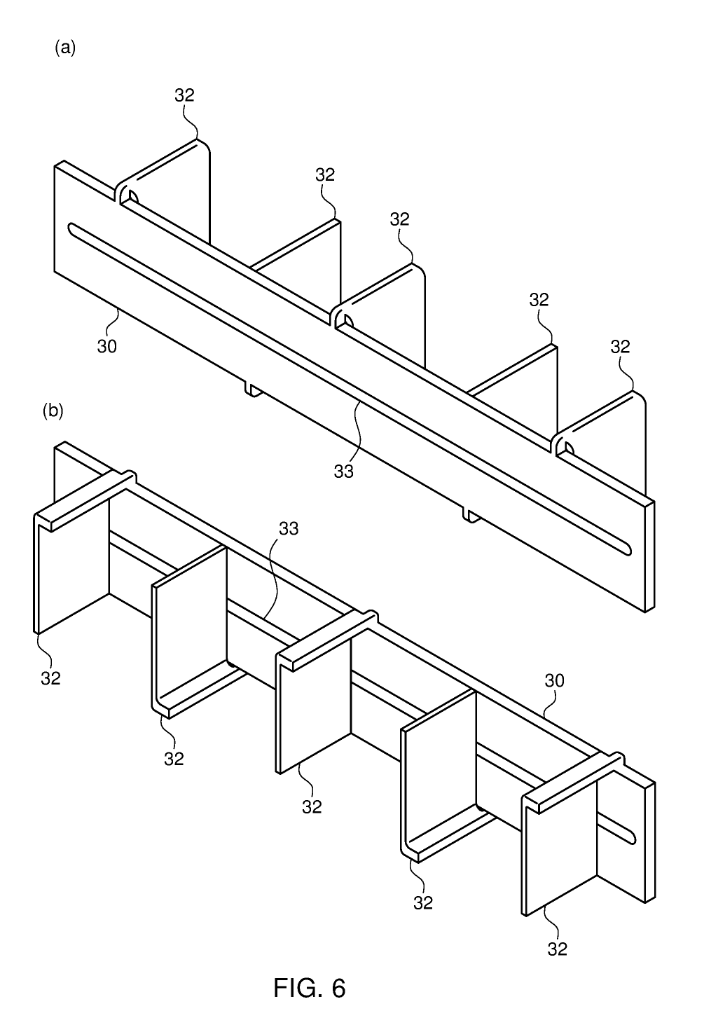

As illustrated in FIG. 5, the first slit plate 20 in the second embodiment is such that substantially the center of a surface in the Y direction is formed with a concave-shaped groove 23, and inside the groove 23, a first slit 21 penetrating in the thickness direction is formed. In addition, a plurality of light blocking members 22 are integrally provided inside at intervals in the X direction so as to partition the first slit 21.

The light blocking members 22 are provided so as to have the same thickness as the first slit 21, and the first slit 21 resulting from the partitioning by adjacent light blocking members 22 has a long hole shape whose long axis direction coincides with the array direction of the LEDs 2 and width in the long axis direction is configured to be the same as or more than the width of an LED 2. In doing so, the light blocking members 22 and the LEDs 2 have a non-overlapping positional relationship in the X direction, and light traveling at an angle almost along the Z direction can be prevented from being blocked by the light blocking members 22. Note that the first slit 21 is not limited to being of such a long hole shape, but may be of, for example, a rectangular shape or an elliptical shape.

Since the linear light irradiation device of the second embodiment configured as described above is such that the light blocking members 22 block the light spreading in the X direction at a predetermined angle or more with respect to the Z direction, it can prevent the line width of the linear light from widening, as with the first embodiment.

Also, since the light blocking members 22 are arranged inside the first slit 21 differently from the first embodiment, the device can be further miniaturized. In addition, since the first slit 21 is formed in the groove 23 where the thickness of the first slit plate 20 is reduced, a distance that light passes through the first slit 21 can be shortened to reduce the light reflected by the inner peripheral surfaces of the slit 21.

### THIRD EMBODIMENT

A linear light irradiation device of a third embodiment is such that the configuration of a first slit plate 30 is different from those in the first and second embodiments. However, the other parts are the same as those in the first and second embodiments, and therefore the same parts are denoted by the same symbols to omit description.

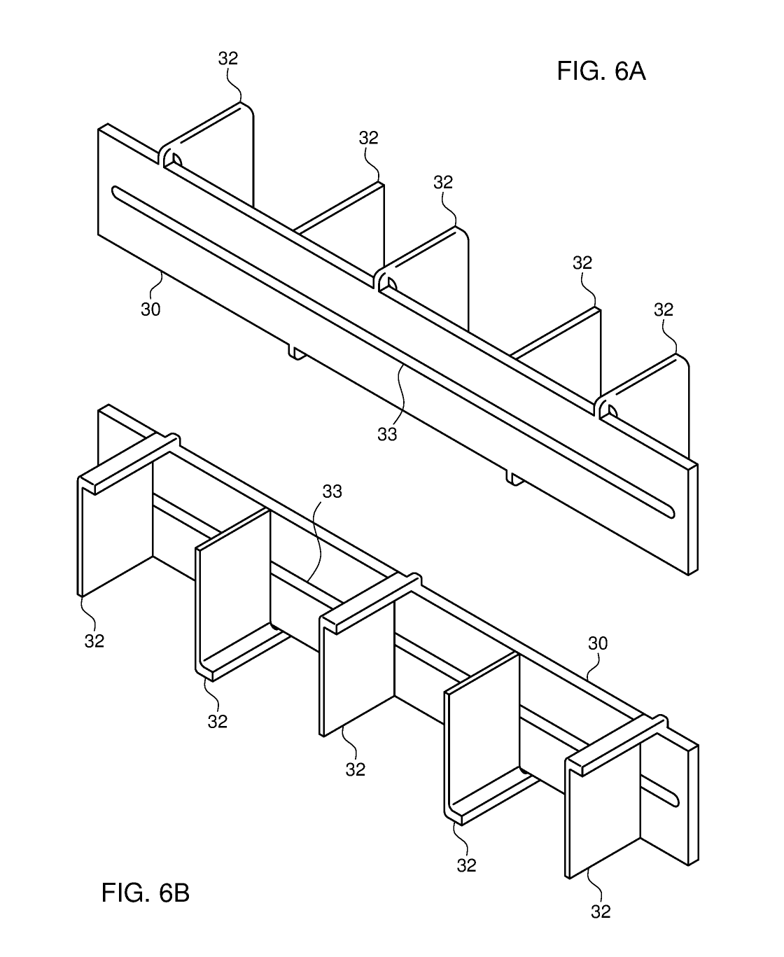

As illustrated in FIGS. 6(a) and (b), the first slit plate 30 in the third embodiment is such that a long first slit 33 extending in the X direction is provided penetrating in the thickness direction thereof (Z direction) in substantially the central part in the Y direction.

In addition, on the first slit plate 30, light blocking plates 32 are arranged so as to cross the first slit 33 and rise from the front surface of the first slit plate 30. The light blocking plates 32 are formed by connecting one ends thereof to any of the lateral end surfaces connecting between the front surface and back surface of the first slit plate 30, and performing a bending process. In the following, a method for the process will be described.

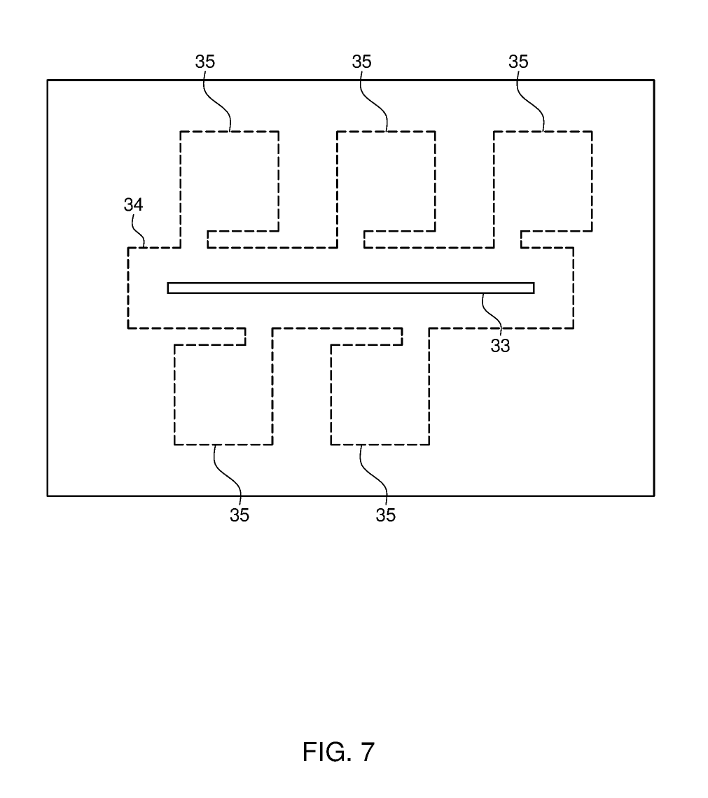

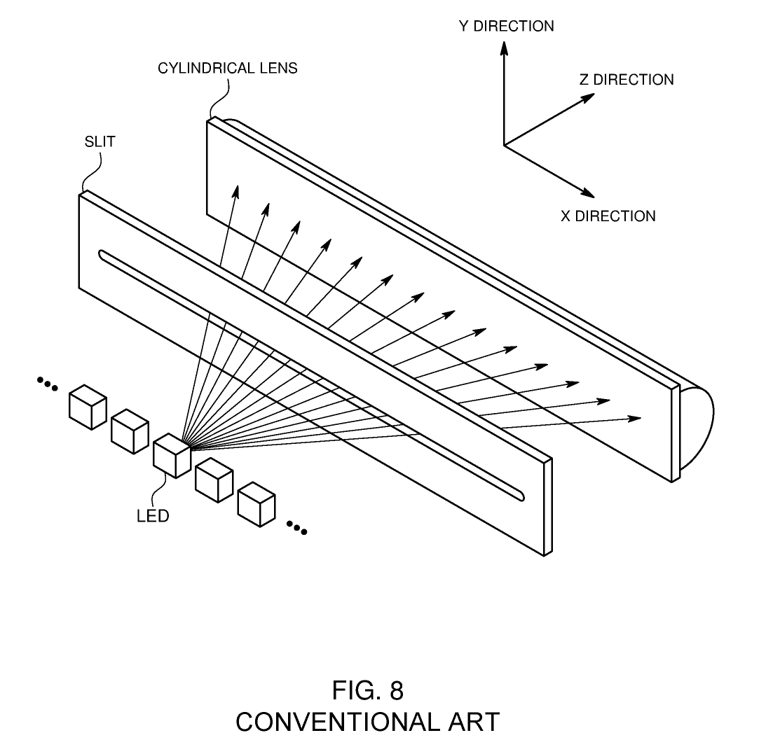

As illustrated in FIG. 7, the first slit 33 is formed in substantially the center of one plate member, and also the periphery (a part 34 to become the first slit plate) of the first slit 33 formed is cut out. At this time, parts 35 to become the light blocking plates are left connected to the part 34 that is to become the first slit plate. Then, the parts 35 left in order to become the light blocking plates are subjected to the bending process and bent so as to rise from the first slit plate 30.

Since the linear light irradiation device of the third embodiment configured as described above is such that by performing the bending process on the one member, the first slit plate 30 and the light blocking plates 32 provided integrally therewith are formed, it can be a low cost linear light irradiation device.

Note that the present invention is not limited to the above-described embodiments.

For example, the opening shapes of the first slit and the second slit are not limited to ones in the above-described embodiments, but may be configured to be a tapered shape whose opening width increases or decreases with distance from the LEDs.

Also, by protruding a slit formation part of a slit plate so as to increase the thickness of the slit formation part and arranging the LEDs near the protruded slit formation part, the length of the device in the Z direction can be further shortened to further miniaturize the device as well as to improve light utilization efficiency.

In addition, when LED chips are used as the LEDs, making the longer direction of an LED chip and the longer direction of a slit coincide enables light utilization efficiency to be improved.

In the above-described embodiments, the second slit plate is provided on the light emitting side of the condenser lens; however, the second slit plate may be provided on the incident side of the condenser lens. In addition, the second slit plate may be one in which a plurality of slits are linearly arrayed as with the light blocking plates, or may be one provided with a heat radiation fin. Further, when the above-described first slit plate, the light blocking plates, and the condenser lens make it possible to obtain a desired line width, the second slit plate can be omitted.

Also, the shape of the light blocking plates is not limited to the ones in the above-described embodiments, but may be, for example, one provided rising on both of the front and back surfaces of the first slit member so as to cross the first slit. Further, the number of light blocking plates is not limited to ones in the above-described embodiments but can be appropriately changed.

The present invention can be variously modified without departing from the scope thereof.

### INDUSTRIAL APPLICABILITY

According to the present invention, a linear light irradiation device capable of preventing the widening of the line width of linear light and uniforming the line width can be provided.

1. A linear light irradiation device adapted to apply linear light, the linear light irradiation device comprising:
a plurality of LEDs that are linearly arrayed;
a light condensing member that condenses light emitted from each of the LEDs; and
a first slit member formed with a first slit that extends along an array direction in which the plurality of LEDs are arrayed and allows a portion of the light emitted from each of the LEDs to pass, wherein
the first slit member is integrally provided with a plurality of light blocking members that are arranged at intervals in the array direction.

2. The linear light irradiation device according to claim 1, wherein
the first slit member is formed of a flat plate-shaped member through which the first slit penetrates in a thickness direction, and
each of the light blocking members is formed of a plate-shaped body that crosses the first slit and rises from a surface of the first slit member.

3. The linear light irradiation device according to claim 2, wherein
each of the light blocking members is formed by a bending process to be in a state of crossing the first slit and rising from the surface of the first slit member.

4. The linear light irradiation device according to claim 1, wherein
the first slit member is formed of a flat plate-shaped member through which the first slit penetrates in a thickness direction, and
each of the light blocking members is arranged inside the first slit so as to partition the first slit.

5. The linear light irradiation device according to claim 1, wherein
the first slit member is arranged between the plurality of LEDs and the light condensing member, and
the light blocking members are arranged on a side of the light condensing member.

6. The linear light irradiation device according to claim 1, further comprising:
a second slit member formed with a second slit that allows a portion of the light condensed by the light condensing member to pass.
